(19) United States
(12) Patent Application Publication
(10) Pub. No.: US 2001/0049647 A1
(43) Pub. Date: Dec. 6, 2001

(54) Multi-round auction and internet marketplace

(76) Inventors: Andrew Sheehan, San Francisco, CA (US); Guy Yalif, San Francisco, CA (US)

Correspondence Address: GLENN PATENT GROUP, 3475 EDISON WAY, SUITE L, MENLO PARK, CA, 94025, US

(21) Appl. No.: 09/746,022

(22) Filed: Dec. 21, 2000

Related U.S. Application Data
(60) Provisional application No. 60/171,699, filed on Dec. 22, 1999.

(51) Int. Cl. G06F 17/60

(52) U.S. Cl. 705/37; 705/26

(57) ABSTRACT

A marketplace comprises an Internet website and webserver that allows frequent buyers and sellers to pre-register and pre-qualify one another so that surplus merchandise can find a quick and ready market. Such marketplace includes retail content, authenticated trading, staged auctions, trading tools, and integrated purchase-order fulfillment. Pre-registered and pre-qualified users are issued passports to the website. Sellers issue visas to potential buyers they wish to invite to select pre-auctions of special merchandise. Any remaining merchandise is then offered in a public auction.

### BACKGROUND OF THE INVENTION

1. Technical Field

The present invention relates to wholesale and retail marketing, and more specifically to Internet hosting of trading communities with pre-registered buyers and sellers who participate in pre-auctions and public auctions.

2. Description of the Prior Art

Ad hoc auctions that occur infrequently between buyers and sellers have been growing in popularity on the Internet. In particular, eBay is now hosting millions of auctions everyday. A portion of the eBay users are professional buyers and sellers trying to conduct their businesses with the simple and sometimes not-so-convenient forum provided.

Each buyer must find each seller for every auction. Buyers can use search engines to find auctions that might interest them. Buyers can bookmark search results and even particular seller's auctions, and this helps if the buyer is more than a casual visitor. Sellers sometimes will think to send an e-mail to buyers they've done business with before, or to buyers they've seen bid on similar items.

As will naturally occur, informal trading groups will develop amongst frequent buyers and sellers. Occasionally, a seller will privately offer an item to a familiar buyer before placing it on public auction. Communities like eBay, and others, don't really offer any support for or recognize this type of trading activity.

Apart from the Internet, small businesses have the well-known disadvantage of lacking the buying power of large corporations. Banding together into groups has always been a good strategy to capture some of the advantages of buying in volume to receive discounts.

What is needed is an efficient and easy-to-use trading forum that allows frequent buyers and sellers to pre-register and pre-qualify one another so that surplus merchandise can find a quick and ready market.

### SUMMARY OF THE INVENTION

Briefly, a marketplace embodiment of the present invention comprises an Internet website and webserver that allows frequent buyers and sellers to pre-register and pre-qualify one another so that goods and services can find a quick and ready market. Such marketplace includes retail content, authenticated trading, staged auctions, trading tools, and integrated purchase-order fulfillment. Pre-registered and pre-qualified users are issued passports to the website. Sellers issue visas to potential buyers they wish to invite to select pre-auctions of special merchandise. Any remaining merchandise is then offered in a public auction.

### BRIEF DESCRIPTION OF THE DRAWINGS

FIG. 1 is a functional block diagram of a marketplace embodiment of the present invention; and

FIG. 2 is a flowchart of an auction method embodiment of the present invention.

### DETAILED DESCRIPTION OF THE INVENTION

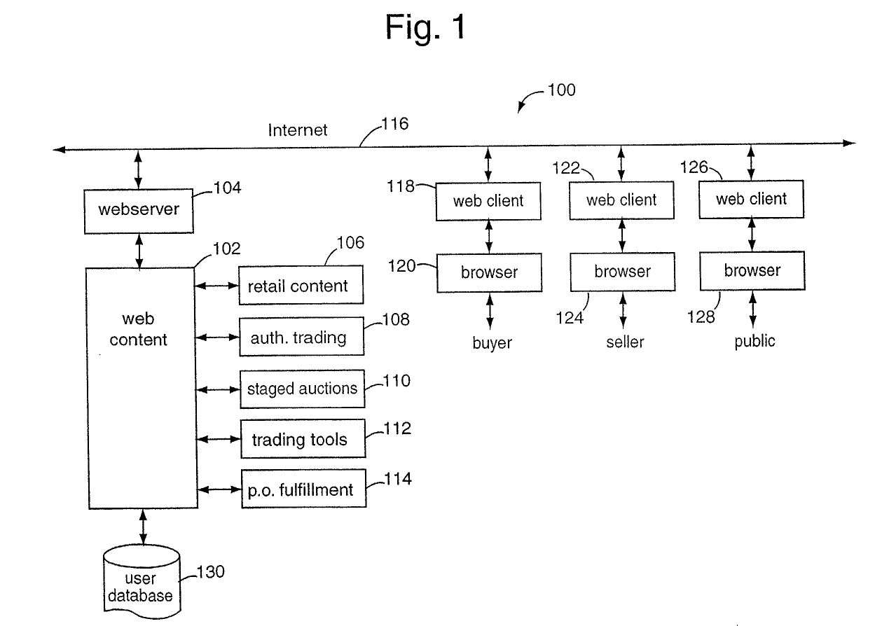

FIG. 1 represents a marketplace embodiment of the present invention, and is referred to herein by the general reference numeral 100. The marketplace 100 comprises an Internet website content 102 and webserver 104 that allows frequent buyers and sellers to pre-register and pre-qualify one another so that good and services can find a quick and ready market. Such Internet website content 102 includes a retail-content computer-program module 106, an authenticated trading computer-program module 108, a staged-auctions computer-program module 110, a trading-tools computer-program module 112, and an integrated purchase-order fulfillment computer-program module 114.

An Internet connection 116 allows a buyer-seller community and the public to log-on to the marketplace 100. For example, in FIG. 1, all pre-registered buyers are represented by a buyer's web-client 118 and a browser 120. All pre-registered sellers are represented by a seller's web-client 122 and a browser 124. The public are represented in FIG. 1 by a web-client 126 and a browser 128.

All pre-registered companies can buy and/or sell, they only take on the temporary roles of buyer or seller as in FIG. 1. A database 130 is used to store all of the information provided by users when they register. Such information includes all the basic things necessary to facilitate sales between users, and preferences that each have for types and kinds or merchandise, etc. Members of the public, e.g., companies, become pre-registered users who are issued “passports” when they register and provide all the required information. The information required and then stored is comprehensive.

The database 130 is also used to store all of the information provided by sellers about the items for sale when they start an auction. Such includes text, graphics, and sound files that help promote and interest buyers.

Passport holders can be issued temporary or permanent “visas” by particular sellers. Such visas are implemented with network cookies. Visas can be requested (marketing pull strategy), or provided (marketing push strategy). Buyers can scan the database 130 for interesting items and sellers, and thereby request a visa. Sellers can also scan the database 130 for likely buyers, and thereafter send an unsolicited visa. Such visas allow special access and visibility of the visa holder to first-round and pre-auction activities of sellers.

The retail-content computer-program module 106 collects and disseminates news and other information needed by the users to stay on top of relevant events that could affect their businesses and business activities. Sources of information can be contributed by a professional journalist staff and the users themselves.

The authenticated trading computer-program module 108 issues passports to pre-registered and pre-qualified users for their access to the marketplace 100. Sellers can issue temporary or permanent visas to potential buyers they wish to invite to select pre-auctions of special merchandise. Any remaining merchandise is afterward offered in a public auction. Such visas allow sellers to control their sales channel and brand strategies.

The staged-auctions computer-program module 110 manages the posting and conduct of the pre-auctions and public auctions. E-mails are sent to the visa holders that announce each relevant pre-auction. Participants in the public auctions are not informed of any pre-auction activity or results. They only see the remainder in the public auction.

The trading-tools computer-program module 112 allows buyers to post profiles of the merchandise they will buy, and e-mails are automatically generated to buyers to notify them that such merchandise has been posted for sale. Such also includes search engines that help buyers find particular auctions.

The integrated purchase-order fulfillment computer-program module 114 synchronizes company purchasing and logistic systems with others. The formalities of purchasing and shipping after an auction is concluded are automatically handled according to pre-established information and procedures included in each user's passport.

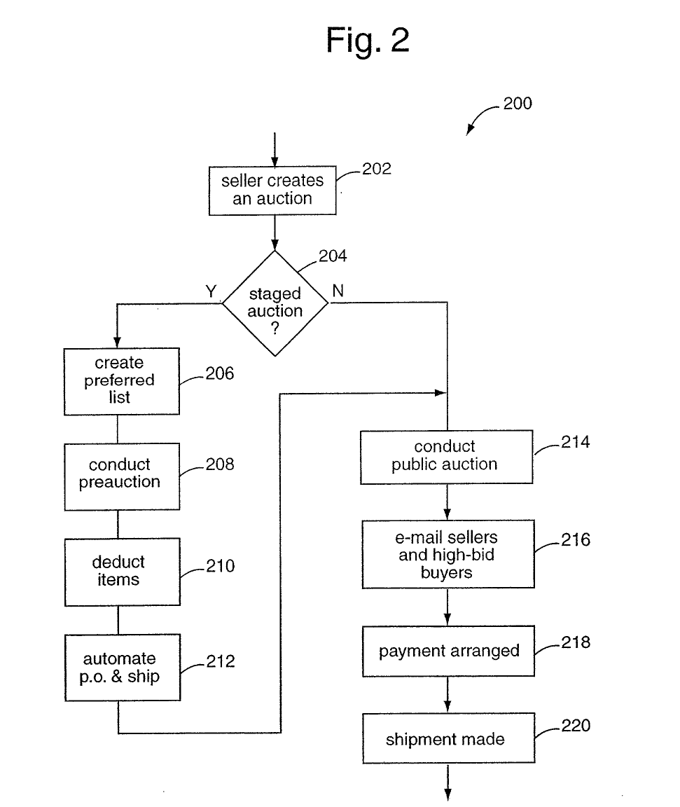

FIG. 2 is an auction method embodiment of the present invention, and is referred to herein by the general reference numeral 200. The method 200 creates auctions communicated over the Internet between retailers, vendors, manufacturers, and wholesalers at network client sites. The essence of each auction is familiar, sellers post items for bids for a limited time. Buyers posts bids, and the top bidder when the time expires “wins” the auction.

In a first round, the method 200 limits who knows of the auction and who is qualified to bid. In a second round, the bidding is opened up to the public. The auction method 200 comprises a step 202 in which a seller creates an auction. A clear description of the items to be auctioned is submitted. In a step 204, the seller may elect to have a staged-auction, in which existing trading partners are given a first-shot at the items. A step 206 creates a list of preferred trading partners, and each is sent an e-mail announcing the pre-auction. A preferred-round step 208 conducts a private first-round pre-auction for these preferred trading partners. The preferred-round step 208 ends at an appointed time, or when a minimum number of items have received bids. Any items sold during such pre-auction are deducted from a total remaining in a step 210.

A step 212 automatically generates purchase orders and bills-of-lading or other appropriate fulfillment documents and instructions for the sold-merchandise. Such can be implemented by electronically accessing buyer and seller ERP backend systems. Each buyer inputs purchase order information which lands in the seller's system seamlessly. For example, the products of QRS Corporation (Richmond, Calif.) can be used to implement this function.

A second-round auction begins with a step 214. Passports and visas are not needed by the public in order to participate. But, how wide a public offering is made is strictly controlled by the parameters that the seller enters in step 202. After the auction concludes, an e-mail is automatically generated and sent to the sellers and the high-bidders in a step 216. Satisfactory payment arrangements are made in a step 218 and shipment is made in a step 220.

In general, retailers, manufacturers, vendors and wholesalers can visit over the Internet to initiate and manage trading relationships, access the latest industry news and trends and conduct commerce from a central, secure trading environment. The staged auctions enable a seller to post merchandise for sale that opens up to a larger set of trading partners after a seller-specified period of time. This allows a seller to give preferred trading partners a first opportunity to buy their merchandise before the auction targets a broader set of approved trading partners. Auction-based commerce facilitates pricing discovery which can drive higher returns for both sellers and buyers in a marketplace. Sellers get a fairer, and often higher, price on goods by expanding the number of potential buyers. Buyers gain access to a wider assortment of vendors and goods. This increases their opportunities to get revenue-driving merchandise on their shelves quickly and efficiently.

Although the invention is preferably described herein with reference to the preferred embodiment, one skilled in the art will readily appreciate that other applications may be substituted for those set forth herein without departing from the spirit and scope of the present invention.

Thus, while the discussion above outlines in detail a presently preferred embodiment of the invention, those skilled in the art will recognize that there are other applications of the invention as well. For example:

Staged commerce is not restricted to auctions. Online virtual showrooms can also use staged commerce. In a showroom, staged commerce first opens up the showroom to one group of buyers and, after some specific event, opens the showroom up to another group of buyers;

Staged commerce does not exclude round one buyers from subsequent rounds of purchasing. For example, if Buyer A and Buyer B are the buyers allowed into a showroom during round one, there is no reason that round two should not include Buyer A, Buyer B, Buyer C, and Buyer D;

Staged commerce is not restricted to surplus merchandise in any way;

Subsequent stages can be triggered by a variety of mechanisms; e.g. the passage of time, the purchase of a certain quantity of merchandise, and lack of purchasing activity for a certain period of time;

Staged commerce applies online and offline; and

Staged commerce can have more than two rounds of buying activity, i.e. the number of rounds is not limited.

Accordingly, the invention should only be limited by the claims included below.

1. A marketplace, comprising:
an Internet website content supported on a webserver that allows frequent buyers and sellers to pre-register and pre-qualify one another so that surplus merchandise can find a quick and ready market;
a retail-content computer-program module included in the Internet website content;
an authenticated trading computer-program module included in the Internet website content;
a staged-auctions computer-program module included in the Internet website content;
a trading-tools computer-program module included in the Internet website content; and
an integrated purchase-order fulfillment computer-program module included in the Internet website content;
wherein, sellers can conduct auctions of merchandise over the Internet in at least two rounds in which a first round is limited to a select group of said buyers.

2. The marketplace of claim 1, wherein:
an Internet connection allows a buyer-seller community and a public to log-on to the marketplace.

3. The marketplace of claim 1, further comprising:
a database for storing information provided by users when registering that includes basic facts necessary to facilitate sales between users, and preferences that each have for types and kinds or merchandise.

4. The marketplace of claim 3, wherein:
the database is such that said users are issued “passports” when they register that are required for a posting of an auction.

5. The marketplace of claim 4, wherein:
the database is such that said users that are issued “passports” are able to issue other users a “visa” that allows them to participate in a private first-round pre-auction.

6. The marketplace of claim 5, wherein:
the database is such that said users who are issued said “visa” request such from a seller.

7. The marketplace of claim 5, wherein:
the database is such that said users who are issued said “visa” are unsolicitedly offered such from a seller.

8. The marketplace of claim 3, wherein:
the database is such that when said users are issued “passports” they are required to identify at least one preferred trading partner.

9. The marketplace of claim 1, wherein:
the retail-content computer-program module collects and disseminates news and other information needed by users to stay on top of relevant events that affect their businesses and business activities.

10. The marketplace of claim 1, wherein:
the authenticated trading computer-program module issues passports to pre-registered and pre-qualified users for their access to the marketplace.

11. The marketplace of claim 1, wherein:
the staged-auctions computer-program module manages any posting and a later conduct of a pre-auction and public auction, and sends e-mails to any visa holders to announce any of relevant pre-auction and public auctions.

12. The marketplace of claim 1, wherein:
the trading-tools computer-program module allows a buyer to post a merchandise profile they will buy, and e-mails are automatically generated to buyers to notify them that such merchandise has been posted for sale.

13. The marketplace of claim 1, wherein:
the integrated purchase-order fulfillment computer-program module provides synchronization of company purchasing and logistic systems with others.

14. A method for creating and communicating auctions of merchandise over the Internet between retailers, vendors, manufacturers, and wholesalers at network client sites, the method comprising the steps of:
submitting a description of merchandise and preferences by a seller to commence an auction;
choosing by said seller whether to have a staged-auction;
if a staged auction, listing at least one preferred buyer who may participate in a first-round pre-auction;
e-mailing each of said preferred buyers a notice that they are invited to participate in said pre-auction;
conducting said first-round pre-auction for said preferred buyers by accepting bids for said merchandise;
deducting any units of said merchandise that received a bid from a total to determine a remaining total of merchandise; and
opening up a wider second-round auction of said remaining total of merchandise to include other than said preferred buyers.

15. The method of claim 14, wherein:
the stop of conducting said first-round pre-auction ends at an appointed time.

16. The method of claim 14, wherein:
the step of conducting said first-round pre-auction ends when a predetermined minimum number of items have received bids.

17. The method of claim 14, further comprising the step of:
automatically generating any purchase orders and a bills-of-lading for any of said merchandise according to information gathered from said seller and said preferred buyer during a registration process.

18. The method of claim 14, further comprising the step of:
registering users who are afterwards able to participate in said pre-auction as a buyer or a seller and issuing a passport upon registration.

19. The method of claim 14, wherein:
the step of listing at least one preferred buyer is such that a visa is granted by said seller to said buyer.
